(19) United States
(12) Patent Application Publication
(10) Pub. No.: US 2016/0109325 A1
(43) Pub. Date: Apr. 21, 2016

(54) METHOD FOR CALCULATING DAMPING BASED ON FLUID INERTIA EFFECT AND FATIGUE TEST METHOD AND APPARATUS USING THE SAME

(71) Applicant: KOREA INSTITUTE OF MACHINERY & MATERIALS, Daejeon (KR)

(72) Inventors: Hakgu LEE, Changwon-si (KR); Jisang PARK, Changwon-si (KR); Doyoung KIM, Buan-gun (KR); Jihoon KIM, Changwon-si (KR); Wookyoung LEE, Gimhae-si (KR); Byeonghyeon LIM, Buan-gun (KR)

(21) Appl. No.: 14/885,728

(22) Filed: Oct. 16, 2015

Related U.S. Application Data
(60) Provisional application No. 62/065,246, filed on Oct. 17, 2014.

(51) Int. Cl. G01M 7/02

(52) U.S. Cl. CPC G01M 7/025

(57) ABSTRACT

A method for calculating damping based on a fluid inertia effect is provided. Also, a fatigue test method and apparatus using the damping calculation method are provided. According to an embodiment, in a resonance fatigue test method for a test article, a processor of the apparatus calculates a damping ratio by considering an air inertia damping caused by a delayed response of air flow development among a fluid inertia effect on an oscillation of the test article. Then the processor constructs a damping model for predicting at least one of an amplitude of the test article and a test bending moment, based on the calculated damping ratio, and performs a resonance fatigue test based on the constructed damping model.

### TECHNICAL FIELD

The present invention relates to technique to calculate damping for various oscillatory structures. More particularly, this invention relates to a method for calculating damping based on a fluid inertia effect and also to a fatigue test method and apparatus using the damping calculation method.

### BACKGROUND

There are many kinds of oscillatory structures in the world. For example, a wind turbine blade used for a wind generator oscillates by, e.g., an exciter mounted thereon, during a fatigue test for reliability verification. Additionally, numerous surrounding structures or constructions such as bridges or buildings often oscillate because of natural phenomena such as heavy wind or earthquake. Similarly, ocean floating constructions oscillate due to big waves, and also a solar panel or an antenna installed on a satellite oscillates in case of an attitude control or the like. In order to design, test and operate such structures or constructions that may be often placed in an oscillation state, it is needed to exactly analyze and calculate various mechanisms associated with oscillation.

For example, in case of a wind turbine blade, damping governs vibration responses of the blade, affecting its load and fatigue life. Also, damping ratios of a wind turbine blade affect the oscillating amplitude when blade fatigue testing, which is a mandatory procedure for compliance to international standards and equivalent guidelines for the blade certification. Thus, the prediction of damping ratios of a wind turbine blade is a crucial topic in the wind industry.

It has been said that damping of a wind turbine blade in oscillatory motion comes from material and structural damping and aerodynamic damping. However, despite some previous studies, the exact prediction of damping in oscillatory motion is still a challenge.

In diverse fields such as wind industry and ocean engineering, fluid encompassing a large structure affects its oscillatory motion severely. To analyze this phenomenon, the concept of an oscillatory drag coefficient associated with fluid dynamic drag phenomenon has been used for a long time. However, this approach has not succeeded in obtaining a general value of the coefficient for a given shape because the coefficient varies with respect to structural dimensions. This makes it difficult to apply the coefficient measured from a small scale model directly to a real structure.

### SUMMARY

Accordingly, in order to address the aforesaid or any other issue, the present invention proposes a new concept of fluid inertia damping caused by a delayed response of flow development. This allows the exact prediction of a fluid effect on a large cantilever beam in oscillatory motion such as a wind turbine blade. In addition to the fluid inertia damping, two more damping phenomena, a drag effect and material damping, are also modeled and then merged into a single modal damping ratio based on energy balance.

According to an embodiment of the present invention, provided is a damping calculation method based on a fluid inertia effect on an oscillation of a structure. This method may include calculating a damping ratio by considering a fluid inertia damping caused by a delayed response of flow development among the fluid inertia effect.

In this method, the calculated damping ratio may be applied to construction of a damping model or measurement of damping.

Also, in this method, the structure may be one of a wind turbine blade, a bridge, a building, an ocean floating construction, a solar panel or an antenna installed on a satellite, or any other structure which has a possibility of oscillation.

According to another embodiment of the present invention, provided is a resonance fatigue test method for a test article. This method may include steps of calculating a damping ratio by considering an air inertia damping caused by a delayed response of air flow development among a fluid inertia effect on an oscillation of the test article; constructing a damping model for predicting at least one of an amplitude of the test article and a test bending moment, based on the calculated damping ratio; and performing a resonance fatigue test based on the constructed damping model.

In this method, the calculating step may include further considering at least one of an aerodynamic drag of the test article and a material damping of the test article.

Additionally, in this method, the constructing step may include constructing a single damping model by merging at least one of the aerodynamic drag and the material damping with the air inertia damping in view of an energy balance.

According to still another embodiment of the present invention, provided is a resonance fatigue test apparatus for a test article. This apparatus may include a test stand configured to fix one end of the test article; an exciter mounted on the test article and configured to apply a repeated force to the test article so as to induce oscillation; a controller connected to the exciter and configured to apply a driving force to the exciter; and a processor configured to calculate a damping ratio by considering an air inertia damping caused by a delayed response of air flow development among a fluid inertia effect on an oscillation of the test article, to construct a damping model for predicting at least one of an amplitude of the test article and a test bending moment, based on the calculated damping ratio, and to offer a control signal for performing a resonance fatigue test based on the constructed damping model to the controller.

In this apparatus, the processor may be further configured to calculate the damping ratio by further considering at least one of an aerodynamic drag of the test article and a material damping of the test article.

Also, in this apparatus, the processor may be further configured to construct a single damping model by merging at least one of the aerodynamic drag and the material damping with the air inertia damping in view of an energy balance.

In the above method and apparatus, the test article may be one of a wind turbine blade, a bridge, a building, an ocean floating construction, a solar panel or an antenna installed on a satellite, or any other structure which has a possibility of oscillation.

### BRIEF DESCRIPTION OF THE DRAWINGS

FIG. 1A is a diagram illustrating a balance between an energy supply and an energy loss in a model for a cantilever beam oscillating at its natural frequency.

FIG. 1B is a diagram illustrating dampers and an external force in a model for a cantilever beam oscillating at its natural frequency.

FIG. 2 is a diagram illustrating a relationship between a representative fluid volume and a representative area.

FIG. 3 is a diagram illustrating an equivalent damper model according to the present invention.

FIG. 4 is a graph illustrating chord distributions of three blades used in an experimental example of the present invention.

FIGS. 5A to 5C are diagrams illustrating test setups for three blades used in an experimental example of the present invention.

FIGS. 6A to 6C are graphs illustrating modal damping ratios measured according to an experimental example of the present invention.

FIG. 7 is a graph illustrating a damping model and three damping mechanisms contributing to the damping model according to an embodiment of the present invention.

FIG. 8 is a schematic diagram illustrating a fatigue test apparatus according to an embodiment of the present invention.

FIG. 9 is a flow diagram illustrating a fatigue test method according to an embodiment of the present invention.

### DETAILED DESCRIPTION

Hereinafter, embodiments of the present invention will be described with reference to the accompanying drawings.

This invention may be embodied in many different forms and should not be construed as limited to the embodiments set forth herein. Rather, the disclosed embodiments are provided so that this invention will be thorough and complete, and will fully convey the scope of the invention to those skilled in the art. The principles and features of the present invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention. Through the drawings, the same or similar reference numerals denote corresponding features consistently.

Unless defined differently, all terms used herein, which include technical terminologies or scientific terminologies, have the same meaning as that understood by a person skilled in the art to which the present invention belongs. Singular forms are intended to include plural forms unless the context clearly indicates otherwise.

Calculation of Energy Loss Based on Damping Phenomena

At the outset, this invention provides technique to calculate an energy loss based on three different damping phenomena.

The first damping phenomenon is a new concept, fluid inertia damping, caused by a delayed response of flow development. Generally when modeling a vibration motion of a cantilever beam with constant amplitude at its natural frequency, the sum of inertia proportional to a beam acceleration and an elastic force proportional to a beam deflection and the sum of a damping force proportional to a beam velocity and a sinusoidal external force constitute the equilibrium equation of force. However, more precisely speaking, the aforementioned description on inertia proportional to the beam acceleration does not include all inertia terms because a fluid which is encompassing a beam may have a slightly delayed response to a beam motion. If the beam deflection is a sine function of time, a fluid inertia force, F_{I}, with a time delay, φ, can be modeled as follows.

F_{I}=−ρV\ddot{x}(tφ)=ρV(2πf_{N})²×sin(2πf_{N}t+φ) [Equation 1]

In Equation 1, ρ, V, \ddot{x}, t, f_{N}, and X are a fluid density, a fluid volume, a beam acceleration, a time, a natural frequency, and an oscillating amplitude, respectively. Equation 1 can be decomposed into in the summation of a sine function and a cosine function of time.

F_{I}=ρV(2πf_{N})²×{cos(φ)sin(2πf_{N}t)+sin(φ)cos(2πf_{N}t)} [Equation 2]

The first term in parentheses, the sine function of time proportional to the beam acceleration, is related to an additional inertia caused by a fluid encompassing a beam. Usually the inertia effect of a high density fluid such as water has been taken into account using the inertia coefficient in Morison's equation, but the inertia effect of a low density fluid such as air has been neglected. The second term in parentheses, the cosine function of time proportional to a beam velocity, is related to an additional damping caused by a fluid inertia. Thus, if the time delay, φ, is small enough, a damping force by fluid inertia, F_{DI}, can be written as follows.

F_{DI}=φρV(2πf_{N})²×cos(2πf_{N}t) [Equation 3]

The second damping phenomenon comes from a drag effect. A drag force, F_{DD}, is proportional to a beam velocity squared.

$${F}_{DD} = \frac{1}{2} {C}_{D} ρ A {\{ \dot{x} ( t ) \}}^{2} = \frac{1}{2} {C}_{D} ρ {A ( 2 π {f}_{N} )}^{2} {X}^{2} {cos}^{2} ( 2 π {f}_{N} t ) \qquad [ Equation 4 ]$$

In Equation 4, C_{D} and A are a drag coefficient and a projection area of a beam, respectively.

The third damping phenomenon is a material damping. A loss factor, is affected by a strain amplitude, an oscillating frequency, a temperature, defects, and the like. Usually the effects of the strain amplitude and the oscillating frequency on a loss factor are described in log-log graphs. If the interesting ranges of the strain amplitude and the oscillating frequency are relatively small, it is possible to assume linear relationships in log-log graphs as shown in equation 5.

ln η=a ln ε+b ln(2πf_{N})+c [Equation 5]

In Equation 5, ε, a, b, and c are a strain, a slope related to the strain amplitude, a slope related the oscillating frequency, and a constant, respectively. For a cantilever beam, the strain is proportional to a curvature, i.e., the second derivative of a beam deflection, x, with respect to z along the beam length direction. Then the loss factor can be expressed by the following equation.

$$η = {{C}_{η} ( \frac{{d}^{2} x}{d {z}^{2}} )}^{a} {( 2 π {f}_{N} )}^{b} \qquad [ Equation 6 ]$$

In Equation 6, C_{η} is the proportional constant in this log-linear material damping model. Thus, the damping force caused by this material damping, F_{DM}, has the following relationship.

$${F}_{DM} = C \dot{x} ( t ) = \frac{1}{2} η {C}_{c} \dot{x} ( t ) = \frac{k η}{2 π {f}_{N}} \dot{x} ( t ) = {{kC}_{η} ( \frac{{d}^{2} x}{d {z}^{2}} )}^{a} {( 2 π {f}_{N} )}^{b} X cos ( 2 π {f}_{N} t ) \qquad [ Equation 7 ]$$

In Equation 7, C, C_{c}, and k are a damping constant, a critical damping constant, and a spring constant of a beam, respectively.

Modeling for Oscillatory Motion of Cantilever Beam

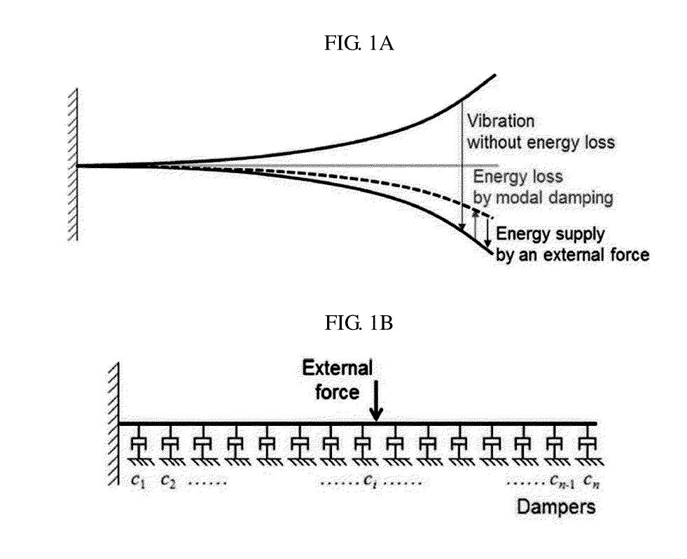

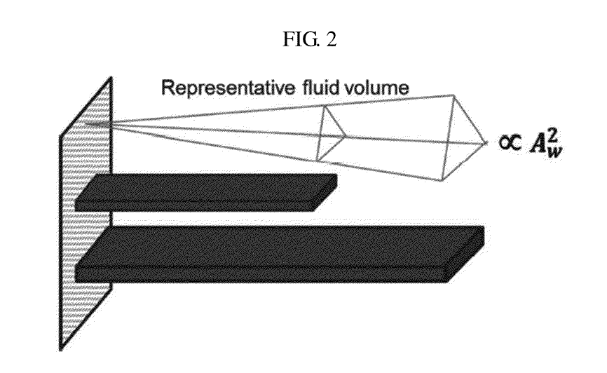

Now, described is to model the oscillatory motion of a cantilever beam at its natural frequency. For a free vibration without energy loss, the amplitude of an oscillatory motion is constant, but in a real situation the amplitude decreases gradually due to damping phenomena as shown in FIG. 1A. To make the amplitude constant, the additional energy supply should be the same as the energy loss from damping. Thus, the energy supply or the energy loss per cycle is proportional to an increment or a decrement in the amplitude, not the amplitude itself. This invention considers the situation that the energy loss occurs everywhere in the beam, whereas the energy supply occurs at a certain point of the beam as shown in FIG. 1B.

The energy supply or the energy loss during the oscillatory motion of a cantilever beam can be calculated using a simple spring model. Herein, a subscript, i, means the i^{th} part of the beam. When an increment of oscillating amplitude, δᵢ, occurs at a certain location of the beam, the potential energy stored in the beam, Uᵢ, is expressed as follows.

$${U}_{i} = \frac{1}{2} {k}_{i} {δ}_{i}^{2} = \frac{{F}_{i}^{2}}{2 {k}_{i}} \qquad [ Equation 8 ]$$

In Equation 8, Fᵢ is the force applied on the spring model. Since Uᵢ is the potential energy that has path independence, Fᵢ becomes the amplitude of an oscillatory force. Therefore, the energy loss being the same as a work done by each damping force can be calculated by respectively inserting amplitudes in Equations 3, 4 and 7 into Equation 8. As a result, Equations 9, 10 and 11 are obtained.

$$\begin{matrix}{W}_{DI \_ i} = \frac{1}{2 {k}_{i}} {φ}^{2} {ρ}^{2} {{V}_{i}^{2} ( 2 π {f}_{N} )}^{4} {x}_{i}^{2} & [ Equation 9 ] \\ {W}_{DD \_ i} = \frac{1}{8 {k}_{i}} {C}_{D}^{2} {ρ}^{2} {{A}_{i}^{2} ( 2 π {f}_{N} )}^{4} {x}_{i}^{4} & [ Equation 10 ] \\ {W}_{DM \_ i} = \frac{1}{2} {k}_{i} {{C}_{η}^{2} ( \frac{{d}^{2} x}{d {z}^{2}} )}^{2 a} {( 2 π {f}_{N} )}^{2 b} {x}_{i}^{2} & [ Equation 11 ]\end{matrix}$$

In Equations 9, 10 and 11, where W_{DI}, W_{DD}, and W_{DM} are the work done by each damping force, and xᵢ is the oscillating amplitude of the beam deflection. The projection area of the i^{th} part, Aᵢ, in Equation 10 is the product of the part length, Δzᵢ, and the projection width, l_{c}_{_}ᵢ, of the i^{th} part. Similarly the fluid volume under the i^{th} part, V, in Equation 9 can be modeled as being proportional to the product of the projection area, Aᵢ, and the oscillating amplitude, xᵢ, of the i^{th} part. Substituting the above relationships into Equations 9 and 10 yields the following Equations 12 and 13.

$$\begin{matrix}{W}_{DI \_ i} ∝ \frac{1}{2 {k}_{i}} {φ}^{2} {ρ}^{2} Δ {z}_{i}^{2} {{l}_{c \_ i}^{2} ( 2 π {f}_{N} )}^{4} {x}_{i}^{4} & [ Equation 12 ] \\ {W}_{DD \_ i} = \frac{1}{8 {k}_{i}} {C}_{D}^{2} {ρ}^{2} Δ {z}_{i}^{2} {{l}_{c \_ i}^{2} ( 2 π {f}_{N} )}^{4} {x}_{i}^{4} & [ Equation 13 ]\end{matrix}$$

The time delay, φ, was modeled as follows. The oscillatory damping increases as the plate area increases. This means that with larger fluid volume movement, more energy loss occurs. Thus, this study assumed the time delay is proportional to the representative fluid inertia, i.e. the product of the representative fluid volume and the representative acceleration, which will be expressed based on the representative area. The simplest area which can be calculated is the projection area of a cantilever beam, which is certainly related to the representative fluid volume. However, a relatively large fluid volume moves near the free boundary of a cantilever beam whereas there is no flow development near the clamped boundary. To reflect this tendency, a linear weighted function from 0 to 1 along the beam length direction is devised, and then the representative area, A_{w}, is calculated as follows.

$${A}_{w} = {\sum }_{i = 1}^{n} {A}_{i} \frac{{z}_{i}}{L} = {\sum }_{i = 1}^{n} Δ {z}_{i} {l}_{c \_ i} \frac{{z}_{i}}{L} \qquad [ Equation 14 ]$$

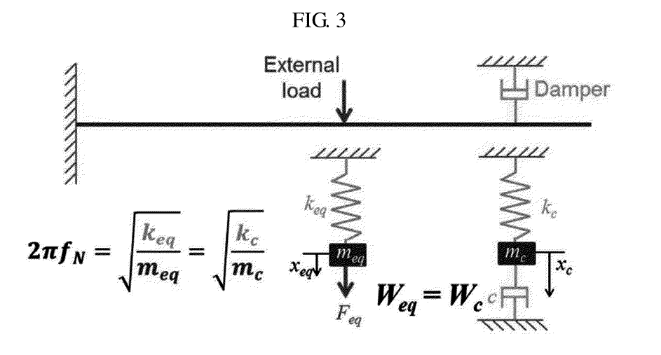

In Equation 14, zᵢ and L are the distance from the clamped condition and the beam length, respectively. The representative fluid volume is the product of A_{w} and the height of the volume. As shown in FIG. 2, if the height is modeled as a length proportional to the product of the beam length and width, then the representative volume becomes proportional to A_{w} squared; for the same beam width the height is proportional to the beam length, and for the same beam length the height is proportional to the beam width. Next the representative acceleration can be modeled as the product of the oscillating frequency squared and the representative length, i.e., the square root of A_{w}. Then the time delay, φ, has the following relationship as shown in Equation 15.

φ∝A_{w}^{2.5}(2πf_{N})² [Equation 15]

Substituting Equation 15 into Equation 12 yields Equation 16.

$${W}_{DI \_ i} = \frac{1}{2 {k}_{i}} {C}_{ξ}^{2} {ρ}^{2} Δ {z}_{i}^{2} {l}_{c \_ i}^{2} {{A}_{w}^{5} ( 2 π {f}_{N} )}^{8} {x}_{i}^{4} \qquad [ Equation 16 ]$$

In Equation 16, C_{ξ} is the proportional constant in this fluid inertia damping model. As a result, each energy loss caused by the fluid inertia damping, the drag effect, and the material damping can be calculated by Equations 16, 13 and 11, respectively.

The energy supply from multiple external loads with the same oscillating frequency of f_{N} can be merged into a single equivalent external load. The strain energy of a beam, Uₑ, under multiple external loads, Fₑ_{_}ᵣ and Fₑ_{_}ₛ, can be expressed as follows.

$${U}_{ɛ} = {\sum }_{r , s = 1}^{m} \frac{{F}_{e \_ r} {F}_{e \_ s}}{2 {k}_{rs}} = \frac{{F}_{eq}^{2}}{2 {k}_{eq}} \qquad [ Equation 17 ]$$

In Equation 17, F_{eq}, kᵣₛ, and k_{eq} are the equivalent external load, the spring constant calculated from a deflection at the position r when an external load, Fₑ_{_}ₛ, is applied at the position s, and the spring constant at the location of the equivalent external load, respectively. From Equation 17, the equivalent external load can be written as follows.

$${F}_{eq} = \sqrt{{\sum }_{r , s = 1}^{m} \frac{{k}_{eq}}{{k}_{rs}} {F}_{e \_ r} {F}_{e \_ s}} \qquad [ Equation 18 ]$$

The energy supply and the energy loss must be the same during constant amplitude oscillation, satisfying the following energy balance equation as shown in Equation 19.

$$\frac{{F}_{ec}^{2}}{2 {k}_{ec}} = {\sum }_{i = 1}^{n} ( {W}_{DI \_ i} + {W}_{DD \_ i} + {W}_{DM \_ i} ) \qquad [ Equation 19 ]$$

Substituting Equations 11, 13 and 16 into Equation 19 yields the following Equation 20.

$$\frac{{F}_{eq}^{2}}{2 {k}_{eq}} = {\sum }_{i = 1}^{n} [ \begin{matrix}\frac{1}{2 {k}_{i}} {C}_{ζ}^{2} {ρ}^{2} Δ {z}_{i}^{2} {l}_{c \_ i}^{2} {{A}_{w}^{5} ( 2 π {f}_{N} )}^{8} {x}_{i}^{4} + \\ \frac{1}{8 {k}_{i}} {C}_{D}^{2} {ρ}^{2} Δ {z}_{i}^{2} {{l}_{c \_ i}^{2} ( 2 π {f}_{N} )}^{4} {x}_{i}^{4} + \\ \frac{1}{2} {k}_{i} {{C}_{η}^{2} ( \frac{{d}^{2} {x}_{i}}{d {z}^{2}} )}^{2 a} {( 2 π {f}_{N} )}^{2 b} {x}_{i}^{2}\end{matrix} ] \qquad [ Equation 20 ]$$

Equivalent Damper Modeling and Equivalent Modal Damping Ratio Calculation

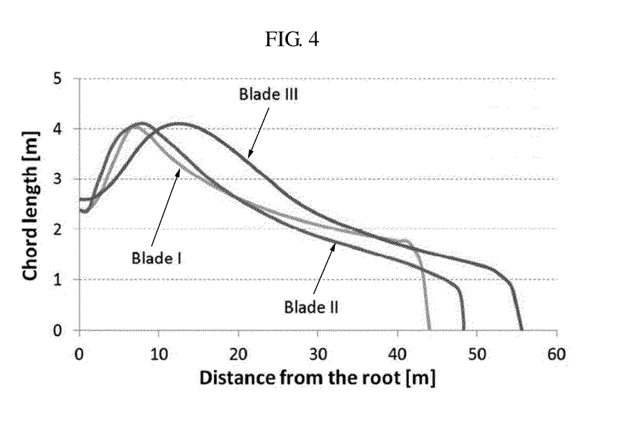

Next, an equivalent damper is modeled to calculate an equivalent modal damping ratio. Generally it cannot be said that the location of the equivalent damper is the same as the location of an external load, so a spring-mass and spring-mass-damper model is constructed as shown in FIG. 3. When an equivalent external load, F_{eq} cos(2πf_{N}t), is applied to a cantilever beam whose natural frequency is f_{N}, its two deflections at the location of the external load and at the location of the equivalent damper become x_{eq} sin(2πf_{N}t) and x_{c} sin(2πf_{N}t), respectively; the mode shape of the beam relates the amplitudes of the two deflections, x_{eq} and x_{c}. Then the work done by the equivalent external load per cycle, W_{eq}, and the work done by the equivalent damping force per cycle, W_{c}, can be expressed as follows.

$$\begin{matrix}{W}_{eq} = {\int }_{0}^{\frac{1}{{f}_{y}}} F \dot{x} d t = {\int }_{0}^{\frac{1}{{f}_{x}}} {F}_{eq} {x}_{eq} ( 2 π {f}_{N} ) {cos}^{2} ( 2 π {f}_{N} t ) d t = π {F}_{eq} {x}_{eq} & [ Equation 21 ] \\ {W}_{c} = π {F}_{c} {x}_{c} = π C ( 2 π {f}_{N} ) {x}_{c}^{2} = π \frac{{k}_{c} {ζ}_{eq}}{π {f}_{N}} ( 2 π {f}_{N} ) {x}_{c}^{2} = 2 π {k}_{ɛ} {ζ}_{eq} {x}_{c}^{2} & [ Equation 22 ]\end{matrix}$$

In Equations 21 and 22, k_{c} and ζ_{eq} are the spring constant at the location of the equivalent damper and the equivalent modal damping ratio, respectively. From the energy balance between Equations 21 and 22, the equivalent modal damping ratio can be written as Equations 23 and 24.

$$\begin{matrix}{ζ}_{ɛ c} = \frac{1}{\frac{{k}_{c}}{{k}_{ɛ c}} {( \frac{{x}_{c}}{{x}_{ɛ c}} )}^{2}} {ζ}_{m} & [ Equation 23 ] \\ {x}_{eq} = \frac{1}{2 {ζ}_{m}} \frac{{F}_{eq}}{{k}_{eq}} & [ Equation 24 ]\end{matrix}$$

In Equations 23 and 24, ζₘ is an intermediate parameter.

Damping Model

Lastly the governing equations of the whole damping model is derived as follows. Dividing both sides of Equation 20 by x_{eq} to the fourth power followed by rearranging the result equation with respect to ζₘ yields the following Equation 25.

$${ζ}_{m}^{4} - {ζ}_{m}^{2 - 2 a} {4}^{( b - a - 1 )} {( π {f}_{N} )}^{2 b} {{C}_{η}^{2} ( \frac{{F}_{eq}}{{k}_{eq}} )}^{2 a} {\sum }_{i = 1}^{n} [ \frac{{k}_{i}}{{k}_{eq}} {( \frac{{x}_{i}}{{x}_{eq}} )}^{2} {( \frac{{d}^{2} ( {x}_{i} / {x}_{eq} )}{d {z}^{2}} )}^{2 a} ] - \frac{1}{4} {( π {f}_{N} )}^{4} {C}_{D}^{2} {ρ}^{2} \frac{{F}_{eq}^{2}}{{k}_{eq}^{4}} {\sum }_{i = 1}^{n} [ Δ {z}_{i}^{2} {l}_{c \_ i}^{2} \frac{{k}_{eq}}{{k}_{i}} {( \frac{{x}_{i}}{{x}_{eq}} )}^{4} ] - 4 {( π {f}_{N} )}^{8} {A}_{w}^{5} {C}_{ζ}^{2} {ρ}^{2} \frac{{F}_{eq}^{2}}{{k}_{eq}^{4}} {\sum }_{i = 1}^{n} [ Δ {z}_{i}^{2} {l}_{c \_ i}^{2} \frac{{k}_{eq}}{{k}_{i}} {( \frac{{x}_{i}}{{x}_{eq}} )}^{4} ] = 0 \qquad [ Equation 25 ]$$

As a result, the governing equations of the whole damping mechanism model in this invention are Equations 23 and 25 with the six characteristic constants, a, b, C_{η}, C_{D}, C_{ξ}, and the equivalent damper's location on the beam. The deflection ratio, xᵢ/x_{eq}, can be determined from the beam's mode shape, and the other information on the beam geometry and stiffness, the natural frequency, the loading condition, and the fluid density is given information. Therefore, if general values of the six characteristic constants are found from measured data, an equivalent modal damping ratio at any condition of a cantilever beam can be calculated from Equations 23 and 25.

### Experimental Example

### Measurement of Damping Radio for Three Blades in Different Test Setups

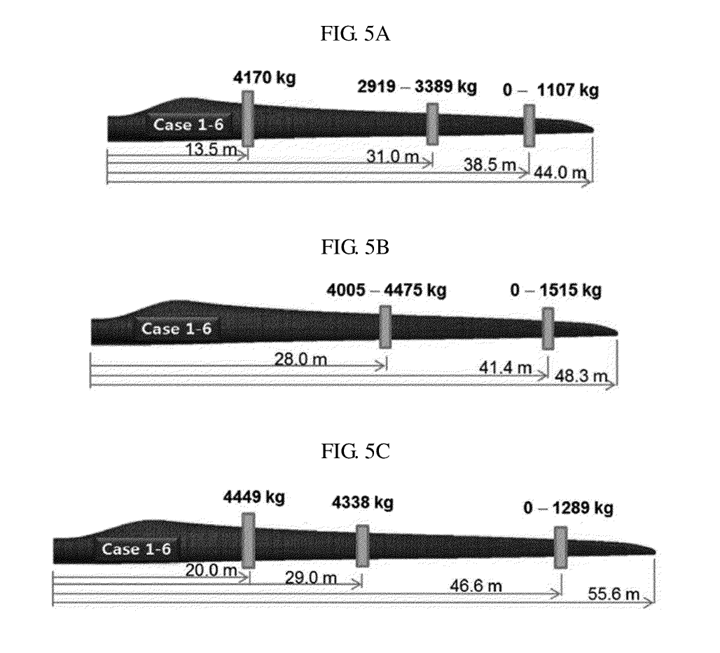

Three different wind turbine blades as shown in FIG. 4 were used to measure damping ratios at various test setups. Table 1 shows the length, mass and first flapwise natural frequency of each blade used in experiments.

TABLE 1

| | | | 1st flapwise natural |
|---|---|---|---|
| | length [m] | mass [kg] | frequency [Hz] |
| Blade I | 44.0 | 9,770 | 0.88 |
| Blade II | 48.3 | 11,630 | 0.72 |
| Blade III | 55.6 | 14,460 | 0.65 |

FIG. 4 is a graph illustrating chord distributions of three blades used in an experimental example of the present invention. As shown in FIG. 4, Blade I and Blade II have similar blade lengths but different chord distributions, and Blade II and III have similar chord distributions but different blade lengths.

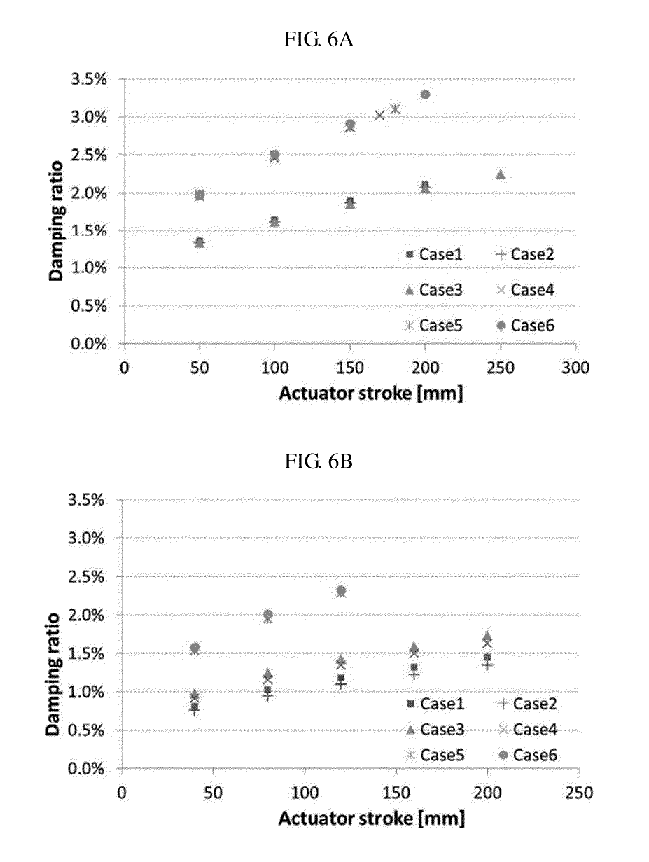

Test setups for calculating damping ratios are as shown in Table 2 and FIGS. 5A to 5C.

TABLE 2

| | | Inside | | | Outside |
|---|---|---|---|---|---|
| | | additional | Exciter [kg] | | additional |
| | Case | mass [kg] | Total mass | Moving mass | mass [kg] |
| Blade | 1 | 4170 | 3389 | 2201 | 1107 |
| I | 2 | | 3154 | 1966 | |
| | 3 | | 2919 | 1731 | |
| | 4 | | 3389 | 2201 | 0 |
| | 5 | | 3154 | 1966 | |
| | 6 | | 2919 | 1731 | |
| Blade | 1 | 0 | 4475 | 2850 | 1515 |
| II | 2 | | 4005 | 2380 | |
| | 3 | | 4005 | 2380 | 1010 |
| | 4 | | 4475 | 2850 | |
| | 5 | | 4475 | 2850 | 0 |
| | 6 | | 4005 | 2380 | |
| Blade | 1 | 4449 | 4338 | 2620 | 1289 |
| III | 2 | | | | 1089 |
| | 3 | | | | 889 |
| | 4 | | | | 689 |
| | 5 | | | | 489 |
| | 6 | | | | 0 |

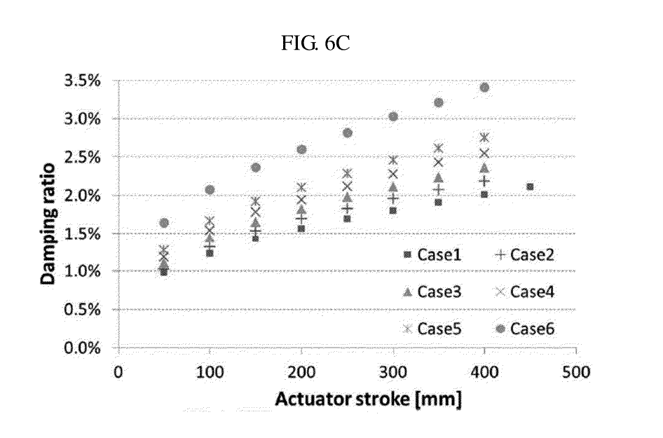

The given information of the three blades are bending stiffnesses, torsional stiffness, line densities, chord lengths, and twist angles of cross sections for each blade. To construct cantilever beam models, commercial FE software ANSYS 15.0 (Canonsburg, Pa.) was used. After generating points at the cross sections, lines were created between the points followed by rotating the lines with respect to pitch-axis up to their principal directions, which can be calculated from the bending stiffnesses. Interpolated material properties at the middle of two adjacent cross sections were applied to each line. Lastly each line was divided into 50 BEAM180 elements, and additional masses at each test setup were attached on each FE model using MASS21 elements. As shown in Table 3, each FE beam model predicted well the first flapwise natural frequency at each test setup with a negligible error of less than 0.34%; in Table 3, the measured natural frequency refers to the oscillating frequencies of the exciter that creates the largest blade acceleration at the same exciter stroke. The acceleration of the tested blade during constant amplitude oscillation was measured by an accelerometer (Model JTF 10G, Honeywell, Morristown, N.J., USA) attached on the blade surface at 35.4 m from the root for Blade I, at 38.0 m for Blade II, and at 42.0 m for Blade III. Using the loading conditions of the exciters and the constructed FE beam models, modal damping ratios of the three blades were measured as shown in FIGS. 6A to 6C.

TABLE 3

| | Blade I | | | Blade II | | | Blade III | | |
|---|---|---|---|---|---|---|---|---|---|
| | Measured | Calculated | Error | Measured | Calculated | Error | Measured | Calculated | Error |
| Case | f_{N} [Hz] | f_{N} [Hz] | [%] | f_{N} [Hz] | f_{N} [Hz] | [%] | f_{N} [Hz] | f_{N} [Hz] | [%] |
| 1 | 0.474 | 0.4729 | −0.24 | 0.433 | 0.4332 | 0.05 | 0.450 | 0.4502 | 0.04 |
| 2 | 0.480 | 0.4789 | −0.23 | 0.435 | 0.4356 | 0.14 | 0.465 | 0.4647 | −0.06 |
| 3 | 0.486 | 0.4851 | −0.18 | 0.480 | 0.4804 | −0.28 | 0.481 | 0.4807 | −0.06 |
| 4 | 0.597 | 0.5973 | 0.05 | 0.476 | 0.4771 | 0.22 | 0.500 | 0.4983 | −0.34 |
| 5 | 0.609 | 0.6103 | 0.21 | 0.620 | 0.6213 | 0.23 | 0.519 | 0.5178 | −0.23 |
| 6 | 0.624 | 0.6241 | 0.02 | 0.632 | 0.6302 | 0.09 | 0.576 | 0.5763 | 0.05 |

In Equation 11, the work done by material damping is proportional to the oscillating amplitude, xᵢ, to the second power, but in Equations 13 and 16, the work done by fluid drag or fluid inertia force is proportional to the oscillating amplitude, xᵢ, to the fourth power. This means that for a small value of xᵢ the energy loss mainly comes from material damping, but for a large value of xᵢ it comes from surrounding fluid such as air. Thus, the slope related to the strain amplitude, a, the slope related the oscillating frequency, b, and the proportional constant in the log-linear material damping model, C_{η}, strongly affect the value of a modal damping ratio at an actuator stroke of 40 mm or 50 mm in FIGS. 6A to 6C. The drag coefficient, C_{D}, was assumed as 2.0, the value for a plate in steady flow. Then the proportional constant in the fluid inertia damping model, C_{ξ}, dominantly affects the value of a modal damping ratio at a large actuator stroke. The last constant, the equivalent damper's location, affects the variation of a modal damping ratio with respect to test setup. As a result, proper values of the six characteristic constants are as shown in Table 4.

TABLE 4

| | | | | | | The location of the |
|---|---|---|---|---|---|---|
| | a | b | C_{η} | C_{D} | C_{ξ} | equivalent damper |
| Blade I | 0.25 | 1.5 | 0.01010 | 2.0 | 0.00065 | 81% of the blade length |
| Blade II | | | 0.00694 | | | |
| Blade III | | | 0.01080 | | | |

The contribution of each damping phenomenon on a modal damping ratio is as follows.

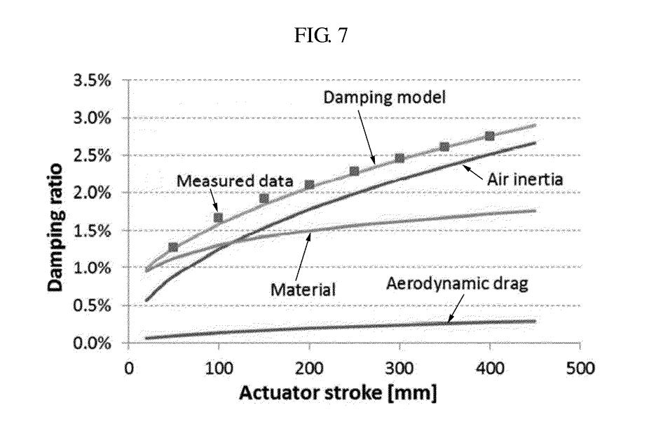

FIG. 7 is a graph illustrating a damping model and three damping mechanisms contributing to the damping model according to an embodiment of the present invention. As shown in FIG. 7, material damping is dominant when the stroke amplitude of the actuator is small, but air inertia damping is dominant when the stroke amplitude is large. The constant term in Equation 25 consists of both fluid drag and fluid inertia. The drag term of the constant is proportional to the natural frequency to the fourth power whereas the inertia term of the constant is proportional to the natural frequency to the eighth power as well as the representative area to the fifth power. Thus for the same blade but different oscillating frequencies, the fluid inertia mainly governs the variation of a modal damping ratio. For the same oscillating frequency but different blades, a modal damping ratio of the larger blade is more severely affected by the fluid inertia. Therefore, among the three damping phenomena the fluid inertia damping is more dominant for a larger wind turbine blade during a faster oscillating motion.

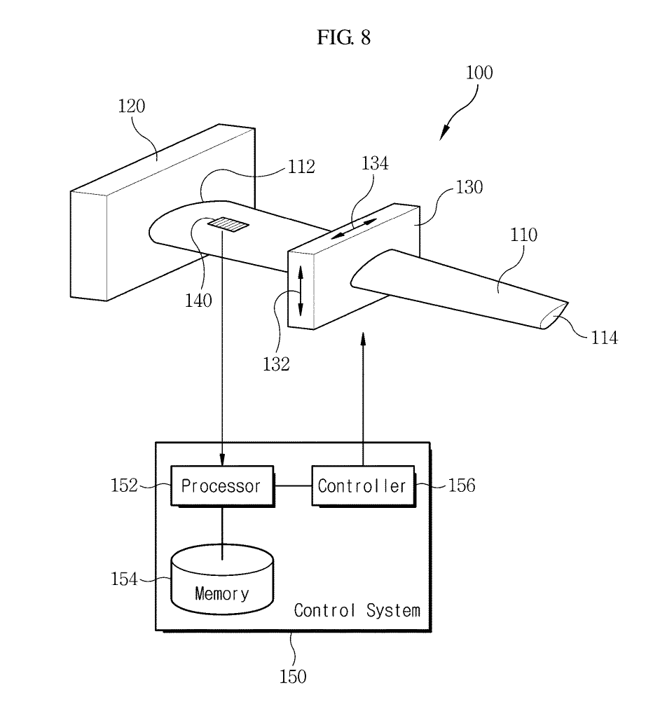

FIG. 8 is a schematic diagram illustrating a fatigue test apparatus 100 according to an embodiment of the present invention. Referring to FIG. 8, the fatigue test apparatus 100 is an apparatus configured to perform a fatigue test for a test article such as a wind turbine blade 110. Although the test article is a wind turbine blade in this embodiment, this is exemplary only and not to be considered as a limitation of the present invention. In other various embodiments, the test article may be a bridge, a building, an ocean floating construction, a solar panel or an antenna installed on a satellite, or any other structure which has a possibility of oscillation.

The blade 110 is fixed to a test stand 120 at one end thereof, i.e., a root 112, thus forming a cantilever beam. The other end of the blade 110 is referred to as a tip 114.

An exciter 130 is mounted on the blade 110. The exciter 130 applies a repeated force to the blade 110 under the control of a controller 156 to be discussed below, thus inducing oscillation of the blade 110. The exciter 130 is illustrated simply in FIG. 8, and types or detailed structures thereof do not limit the invention. Namely, the exciter 130 may have various types such as external exciter type, on-board rotating exciter type, on-board linear exciter type, and the like, and each type exciter may have various structures. For example, in case of on-board linear exciter type, the exciter 130 has an actuator and a mass. The actuator enables the mass to move back and forth linearly, thereby creating an inertia force. A resonance fatigue test adjusts the oscillating frequency of such a linear motion of the mass to approach the natural frequency of the entire blade structure so that resonance occurs.

A fatigue test is controlled by a control system 150, which includes a processor 152, a memory 154, and a controller 156. The memory 154 stores test conditions and data required for or associated with a resonance fatigue test. For example, one of test conditions prescribes that a test bending moment distribution caused by oscillation of the blade 110 should exceed a target bending moment distribution. Data stored in the memory 154 may include blade-related data such as length, mass, first flapwise natural frequency, or the like, a damping ratio calculated considering an air inertia damping, a damping model constructed on the basis of such a damping ratio, and the like.

The controller 156 is connected to the exciter 130 and applies an excitation force to the exciter 130. Namely, based on test conditions and data stored in the memory 154, the controller 156 adjusts the excitation force of the exciter 130 to oscillate the blade 110 with a desired amplitude in a target cycle.

A strain gauge 140 is attached to the blade 110. Although a single strain gauge 140 is shown in FIG. 8 to avoid complexity, at least two strain gauges 140 may be disposed practically. The strain gauge 140 creates a measured signal by measuring a physical quantity (e.g., strain) caused by oscillation of the blade 110 and then transmits the measured signal to the processor 152. The processor 152 processes the measured signal and stores the processed signal in the memory unit 154. Also, based on the processed signal, the controller 156 performs a control operation. The strain gauge 140 is an example of a measurement sensor and not to be considered as a limitation of this invention. Alternatively or additionally, any other sensor such as an optical sensor, an acceleration sensor, a displacement gauge, or the like may be selectively used. If there are a lot of strain gauges 140, a data acquisition device (not shown) may be used for collecting the measured signals from the strain gauges 140 and for transmitting the collected signals to the processor 152.

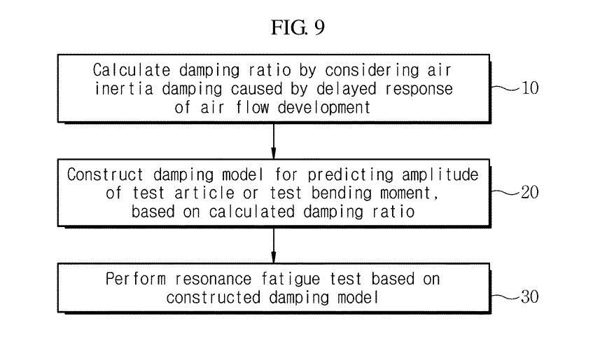

Now, a fatigue test method according to an embodiment of the present invention will be described with reference to FIGS. 8 and 9. FIG. 9 is a flow diagram illustrating a fatigue test method according to an embodiment of the present invention. This method may be performed at the processor 152 of the control system 150 as shown in FIG. 8.

Referring to FIGS. 8 and 9, at step 10, the processor 152 of the control system 150 calculates a damping ratio by considering an air inertia damping caused by a delayed response of air flow development among a fluid inertia effect on an oscillation of the blade 110. At this step, the processor 152 may calculate the damping ration by further considering at least one of an aerodynamic drag of the blade 110 and a material damping of the blade 110. For example, using the above-discussed Equation 23, an equivalent modal damping ratio may be calculated.

Next, at step 20, the processor 152 constructs a damping model for predicting at least one of an amplitude of the blade 110 and a test bending moment, based on the damping ratio calculated at step 10. At this step, the processor 152 may construct a single damping model by merging at least one of the aerodynamic drag and the material damping with the air inertia damping in view of an energy balance. For example, using the above-discussed Equation 25, the damping model may be constructed.

Next, at step 30, the processor 152 performs a resonance fatigue test based on the damping model constructed at step 20. Namely, the processor 152 creates a control signal based on the damping model and offers the control signal to the controller 156 so that the controller 156 can adjust the excitation force of the exciter 130 to oscillate the blade 110 with a desired amplitude in a target cycle.

The above-discussed fatigue test method according to the present invention can be efficiently applied to a test setup procedure for a resonance fatigue test as well as to the full-scale resonance fatigue test.

While the present invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A damping calculation method based on a fluid inertia effect on an oscillation of a structure, the method comprising:
calculating a damping ratio by considering a fluid inertia damping caused by a delayed response of flow development among the fluid inertia effect.

2. The method of claim 1, wherein the calculated damping ratio is applied to construction of a damping model or measurement of damping.

3. The method of claim 1, wherein the structure is one of a wind turbine blade, a bridge, a building, an ocean floating construction, a solar panel or an antenna installed on a satellite, or any other structure which has a possibility of oscillation.

4. A resonance fatigue test method for a test article, the method comprising steps of:
calculating a damping ratio by considering an air inertia damping caused by a delayed response of air flow development among a fluid inertia effect on an oscillation of the test article;
constructing a damping model for predicting at least one of an amplitude of the test article and a test bending moment, based on the calculated damping ratio; and
performing a resonance fatigue test based on the constructed damping model.

5. The method of claim 4, wherein the calculating step includes further considering at least one of an aerodynamic drag of the test article and a material damping of the test article.

6. The method of claim 5, wherein the constructing step includes constructing a single damping model by merging at least one of the aerodynamic drag and the material damping with the air inertia damping in view of an energy balance.

7. The method of claim 4, wherein the test article is one of a wind turbine blade, a bridge, a building, an ocean floating construction, a solar panel or an antenna installed on a satellite, or any other structure which has a possibility of oscillation.

8. A resonance fatigue test apparatus for a test article, the apparatus comprising:
a test stand configured to fix one end of the test article;
an exciter mounted on the test article and configured to apply a repeated force to the test article so as to induce oscillation;
a controller connected to the exciter and configured to apply a driving force to the exciter; and
a processor configured to calculate a damping ratio by considering an air inertia damping caused by a delayed response of air flow development among a fluid inertia effect on an oscillation of the test article, to construct a damping model for predicting at least one of an amplitude of the test article and a test bending moment, based on the calculated damping ratio, and to offer a control signal for performing a resonance fatigue test based on the constructed damping model to the controller.

9. The apparatus of claim 8, wherein the processor is further configured to calculate the damping ratio by further considering at least one of an aerodynamic drag of the test article and a material damping of the test article.

10. The apparatus of claim 9, wherein the processor is further configured to construct a single damping model by merging at least one of the aerodynamic drag and the material damping with the air inertia damping in view of an energy balance.

11. The apparatus of claim 8, wherein the test article is one of a wind turbine blade, a bridge, a building, an ocean floating construction, a solar panel or an antenna installed on a satellite, or any other structure which has a possibility of oscillation.
